(19) United States
(12) Patent Application Publication
(10) Pub. No.: US 2014/0043172 A1
(43) Pub. Date: Feb. 13, 2014

(54) NEXT GENERATION WIRELESS SENSOR SYSTEM FOR ENVIRONMENTAL MONITORING

(71) Applicants: Meso, Inc., Troy, NY (US); Mano Nanotechnologies, Inc., Guilderland, NY (US)

(72) Inventors: John Manobianco, Guilderland, NY (US); John Zack, Rensselaer, NY (US)

(21) Appl. No.: 13/962,017

(22) Filed: Aug. 8, 2013

Related U.S. Application Data
(60) Provisional application No. 61/680,936, filed on Aug. 8, 2012.

(51) Int. Cl. G08C 17/02; G01W 1/10

(52) U.S. Cl. CPC G08C 17/02; G01W 1/10
USPC 340/870.07; 73/170.16

(57) ABSTRACT

Disclosed herein is a drifting airborne probe that includes a body having an aerodynamic shape that is biologically inspired by a wind dispersible natural seed. The probe includes a total mass of less than 10 grams, a power source operably connected to the body; at least one sensor operably connected to the body for collecting data from the environment and about the environment, a transmitter for transmitting the data operably connected to the body and no active propulsion system. Disclosed herein is also a method for collecting and transmitting data about an environment that includes providing a plurality of these drifting airborne probes. Moreover, a system that utilizes a plurality of these drifting airborne probes is also provided.

### FIELD OF TECHNOLOGY

The following relates to an apparatus, system, and method for collecting and transmitting environmental data. More specifically, the following relates to embodiments of an apparatus, system, and method of using miniature disposable airborne probes that function as passive drifters using no active propulsion or flight. Furthermore, the probes are formed in an aerodynamic shape based on bio-inspired designs and integrate micro- and nanotechnology-based components to achieve an ultra-low cost, low mass, miniature-size probe for taking meteorological measurements and communicating the data.

### BACKGROUND

The underlying framework for modern-day weather forecasting is numerical weather prediction (NWP). The NWP physics-based modeling and data assimilation systems integrate time-dependent differential equations with optimized software and use a variety of geophysical data as boundary and initial conditions. The accuracy of NWP is closely linked to the accuracy as well as the spatial resolution, temporal resolution, and coverage of atmospheric observations assimilated into the NWP models. Even the present combination of in situ and remotely sensed observations is insufficient to meet the requirements of NWP.

In situ surface, weather balloon, and aircraft observations are not distributed evenly around the world and are sparse over oceans, high latitudes, and some land areas. State-of-the-science in situ data include commercial aircraft observations, integrated water vapor profiles derived from phase and amplitude measurements of global positioning system (GPS) microwave signals, and in situ/remote sensing of various parameters from unmanned aircraft systems (UAS). However, commercial aircraft and UAS observations are limited in coverage because of routing, flight patterns, and flight path restrictions.

Satellites and radars do not currently provide a complete data set required to predict the weather since they typically do not make direct measurements of all model-dependent variables such as pressure, temperature, and moisture. Space-based observing technology currently provides high spatial resolution, but suffers from inadequate temporal and vertical resolution. Even the most sophisticated current-generation remote sensors (e.g. ground or space-based lidars and infrared instruments) do not provide all-weather capability since they cannot penetrate optically thick clouds. Ground-based remote sensing from existing and proposed Doppler radar, lidar, and wind profilers only covers a fraction of the world's land area and a very small percentage of coastal regions.

The next generation of proposed weather satellites will provide precipitation and all-weather temperature/humidity profiles and global, three-dimensional (3D) tropospheric winds from space-based lidars. However, the next generation satellite platforms are complicated and costly to develop and deploy. Given such limitations, it is anticipated that there will continue to be large gaps in data coverage even when the next generation of in situ and remote sensing systems are deployed.

Current government and commercial weather forecast providers generally have access to the same suite of publicly available data and use similar NWP modeling systems and algorithms to generate products. Therefore, no single system typically outperforms others based on forecast accuracy when aggregated over weeks to months, although substantial variability is common for specific cases, locations, and applications. The key to improving short-range forecasts is to greatly expand coincident measurements of model-dependent variables throughout as much of the atmosphere as possible. Thus, a need exists for an apparatus, system, and method to increase the horizontal resolution of in situ, low-level observations, expanding coincident measurements of model-dependent variables, and improving short-range forecast accuracy beyond current capability.

### SUMMARY

A first general aspect relates to a drifting airborne probe that comprises: a body having an aerodynamic shape that is biologically inspired by a wind dispersible natural seed; a total mass of less than 10 grams; a power source operably connected to the body; at least one sensor operably connected to the body for collecting data from the environment and about the environment; a transmitter for transmitting the data operably connected to the body; and no active propulsion system.

A second general aspect relates to a method for collecting and transmitting data about an environment that comprises: providing a plurality of drifting airborne probes each including: a body having an aerodynamic shape that is biologically inspired by a wind dispersible natural seed; a total mass of less than 10 grams; a power source operably connected to the body; at least one sensor operably connected to the body for collecting data from the environment and about the environment; a transmitter for transmitting the data operably connected to the body; and no active propulsion system; releasing the drifting airborne probe with a deployment mechanism; collecting the data about the environment via the sensor; and transmitting the data to a receiver platform via the transmitter.

A third general aspect relates to a system for collecting and transmitting data about an environment that comprises: a plurality of drifting airborne probes each including: a body having an aerodynamic shape that is biologically inspired; a total mass of less than 10 grams; a power source operably connected to the body; at least one sensor operably connected to the body for collecting data from the environment and about the environment; a transmitter for transmitting the data operably connected to the body, wherein the transmitter generates data using a forward error correction communication protocol; and no active propulsion system; a mechanism to deploy the plurality of drifting airborne probe bodies; and at least one receiver platform, the receiver platform generating signals that are receivable by the plurality of drifting airborne probes using the forward error correction communication protocol.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1 depicts an embodiment of an apparatus for collecting and transmitting data about an environment;

FIG. 1A depicts an embodiment of a passive, drifting airborne probe;

FIG. 2 depicts a flow diagram of a method for collecting and transmitting data about an environment; and

FIG. 3 depicts a system for collecting and transmitting data about an environment;

FIG. 4 depicts another embodiment of a passive, drifting airborne probe; and

FIG. 5 depicts another system for collecting and transmitting data about an environment.

### DETAILED DESCRIPTION

A detailed description of the hereinafter described embodiments of the disclosed apparatus, method, and system are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

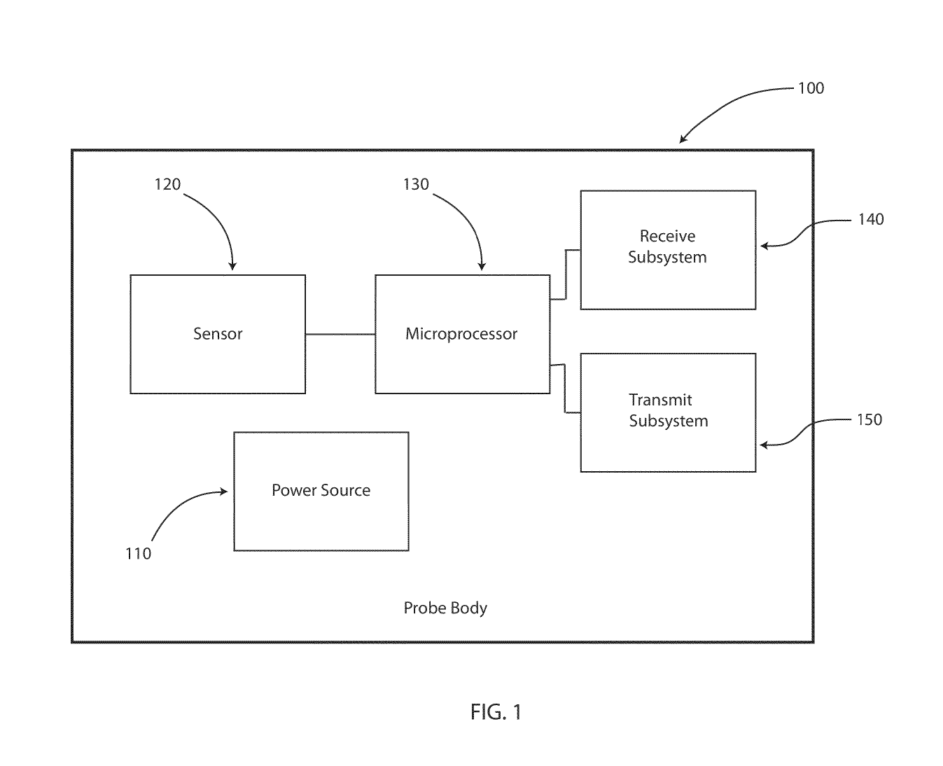

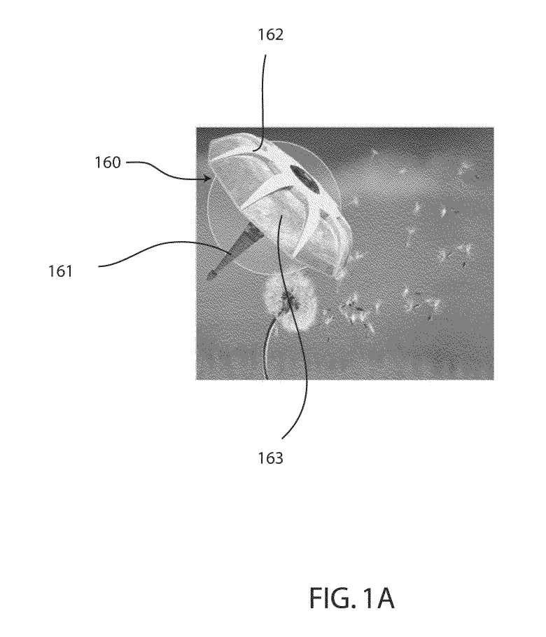

Referring to the drawings, FIG. 1 depicts an embodiment of an apparatus for collecting and transmitting data about an environment. An apparatus may include a probe body 100. Embodiments of a probe body may include micro- and nanotechnology-based components, wireless sensing capability and may function as passive drifters using no active propulsion or flight. The overall probe design may address component geometry, aerodynamic characteristics (mainly terminal velocity), and power consumption. The probes may also be designed as “bioinert” probes so as to minimize the number of components that could have any negative environmental impacts. The probes may also be designed so as to not contain materials or components that pose any more environmental hazards than other weather instrumentation such as radiosondes or dropsondes. The probes may be designed to isolate certain components from the effects of liquid and frozen water as well as direct solar radiation. Flexible electronics may also be utilized to minimize terminal velocities.

Embodiments of probe bodies may include probe bodies whose mass and aerodynamic shape allows them to remain airborne for a period of time, for example between several minutes to 24 hours. Embodiments of a probe body may also include probe bodies which are aerodynamically shaped based on bio-inspired designs. Aerodynamic bio-inspired designs may include shapes that are substantially similar to wind dispersible natural seeds such as dandelion seeds, maple seeds, whirlybirds, samaras, gliders such as the winged seed of the Asian climbing gourd, parachutes such as the seeds of the western salsify, helicopters such as the whirling nut of the Gyrocarpacea family of trees, or flutterers and spinners such as those of the hopseed bush, for example. “Wind dispersible” means seeds that are aerodynamically shaped specifically to laterally disperse, create lift, reduce in fall speed, or automatically rotate during falling in calm or windy environments when compared to non-wind dispersible shapes. “Wind dispersible” does not mean shapes such as pills or spheres, which would not easily disperse in calm or windy environments. In other embodiments, the bio inspired shapes may be shapes of animals like the flying squirrel. Whatever the embodiment, because the probe does not have active propulsion, “bio inspired shapes” mean shapes found in the natural environment from plants or animals which are configured to glide through the air without active propulsion. Therefore, actively moving or flapping wings on birds or insects would be excluded from this definition. However, glider-shaped wings may also provide lift even if there is no active propulsion.

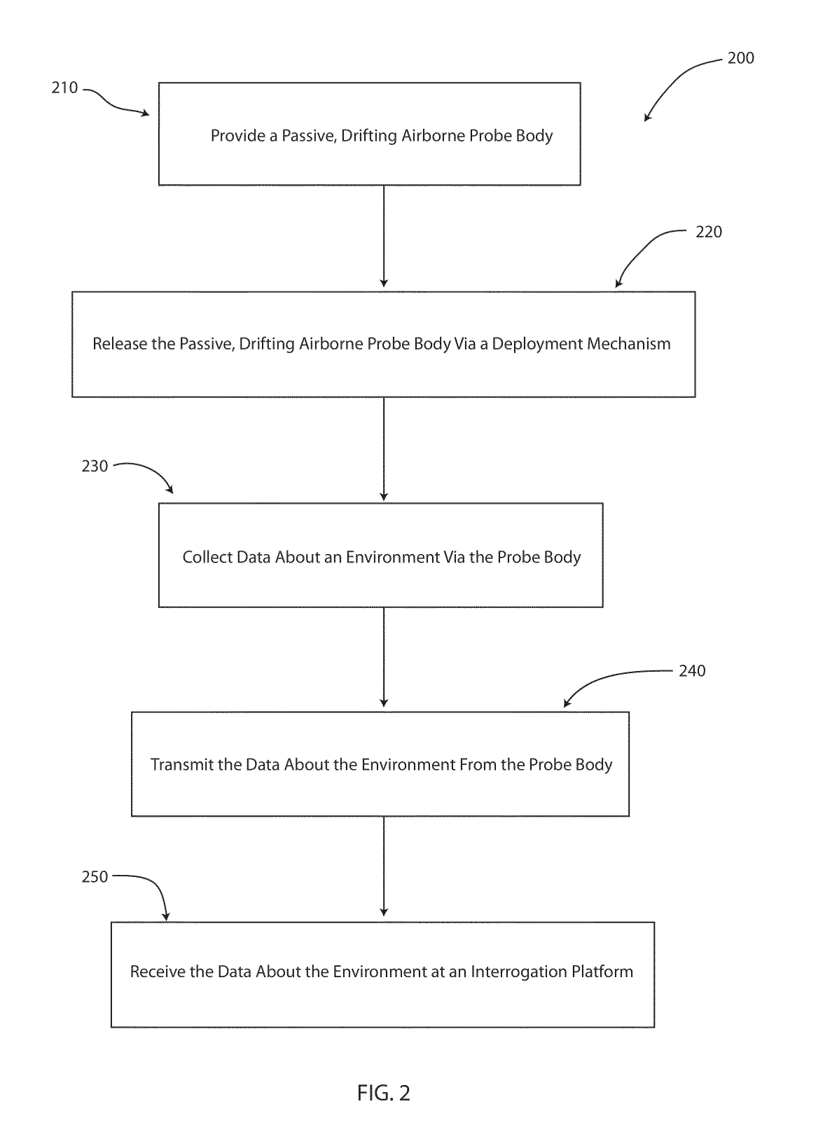

Still further, “biologically inspired” means shapes that include a majority of the features of the original biological entity. For example, as shown in FIG. 2, the biologically inspired probe 160 may include an elongated main stem or sepal 161. Extending from one end of the stem 161 is a plurality of extending elements 162 which are inspired by the seed hairs of a dandelion. It should be understood that the probe 160 may include additional features that are not found in a natural dandelion seed. For example, the probe 160 may include solid webbing 163 extending between the extending elements 162. Thus, to be “biologically inspired” in accordance with the present invention, the probe 160 may not be an exact replica, but may instead simply include a majority of the features of the original biological entity (the stem 161 and the extending elements 162 or hairs).

The definition of “without active propulsion” may not exclude all forms of movement. For example, actively adding an additional flap, or moving a flap, on a probe during flight may not provide active propulsion, but may simply alter the aerodynamic structure or angle of attack of the probe. This would not be considered “active propulsion” as defined in the present disclosure.

Embodiments of a probe body may further include probe bodies having a mass of less than 10 grams, less than 2 grams, or 0.01 to 1 gram. Embodiments of a period of time may include a half hour, one hour, 24 hours, or any other period of time which would allow the probes to collect and transmit data about an environment. Those skilled in the art should appreciate that there may be other embodiments of probe bodies whose mass and aerodynamic shape allow them to remain airborne for a period of time. For example, with minimal vertical air motion, probes released at an altitude of 3 km above the ground may remain airborne for at least 3 hours at a vertical fall velocity of 0.25 m/s, for example. In another embodiment, an airborne probe may have a terminal velocity of less than 0.5 m/s in calm wind. In other embodiments, a terminal velocity of 0.25 m/s in calm wind is achievable with some or all of the bio inspired body shapes described herein above.

Embodiments of data about an environment may include temperature, moisture, humidity, air pressure, altitude, precipitation, velocity, air quality, air pollution, air composition, air chemistry, airborne toxins, radiation, acoustics, magnetic parameters, biological parameters, allergen levels or other atmospheric, meteorological, or environmental data. Embodiments of collecting data may include sensing, detecting, receiving, observing, measuring, monitoring, computing, determining, quantifying, evaluating, or identifying data. Embodiments of transmitting data may include communicating, broadcasting, sending, conveying, delivering, dispatching, or distributing data. Those skilled in the art should appreciate that there may be other embodiments of collecting and transmitting data about an environment.

Referring still to FIG. 1, embodiments of a passive, drifting airborne probe body 100 may include a system power source 110, a sensor 120, a microprocessor 130, a receive subsystem 140, and a transmit subsystem 150. Furthermore, embodiments of apparatus 100 may include a passive drifting airborne body having low mass and aerodynamic, bio-inspired design which allows it to remain airborne for a period of time and collect and transmit data about an environment.

Embodiments of apparatus 100 may include a system power source 110. A system power source may include an energy storage device such as a battery or a fuel cell. Embodiments of a battery may include a thin film battery or a hearing aid battery. Embodiments may also include storing energy in an onboard power source by using nanotechnology-based supercapacitor technology. A system power source may also include harvesting and storing energy. Embodiments of harvesting and storing energy may include harvesting and storing wind energy or solar energy. Embodiments of harvesting and storing solar energy may include thin film solar cells in the top portion of the probe body that may act like a parachute to slow terminal velocity and house an antenna. Those skilled in the art should appreciate that there may be other embodiments of a system power source.

In further reference to FIG. 1, embodiments of a passive, drifting airborne probe body may include a sensor 120. Embodiments of sensors may include micro-sensors used to measure ambient air temperature, moisture, air pressure, atmospheric composition, nuclear radiation, acoustics, magnetic properties, biological properties, probe position, altitude, cosmic radiation, ozone concentration, or other atmospheric, meteorological or environmental data. The sensors may be integrated with RFID tags including an antenna and a microcontroller to coordinate data processing and communication functions. In one embodiment, a commercially available microsensor may be used which requires less than 20 μw of power. Those skilled in the art should appreciate that there may be other embodiments of sensors.

With still further reference to FIG. 1, embodiments of a passive, drifting airborne probe body may include a microprocessor 130. A microprocessor may act as a central processing unit for the probe body. A microprocessor may be a device that accepts data, processes it, and provides results as an output. Embodiments of a microprocessor may include a microprocessor that operates in the microwatt to milliwatt range. Embodiments of a microprocessor may include a general-purpose microprocessor. In one embodiment, the microprocessor may be programmed so that the electronics transmit only when they receive “wake up” commands from the interrogator using 100 μw of power to function. The sleep mode may also enable the microprocessor to cycle other probe functions, such as sensing, thereby conserving power. Additionally, embodiments of a microprocessor may also include a microcontroller or a digital signal processor. Those skilled in the art should appreciate that there may be other embodiments of a microprocessor.

Referring still to FIG. 1, embodiments of a passive, drifting airborne probe body may include a receive subsystem 140 and a transmit subsystem 150. A receive subsystem may be a system designed to receive a signal. A transmit subsystem may be a system designed to transmit a signal. In the embodiment shown in FIG. 1, communication with each probe may be accomplished using far-field, radar responsive RFID technology. However, as will be apparent upon full examination of the present disclosure, there are other communication methods contemplated such as forward error correction technology. These other methods will be described in detail hereinbelow. In an RFID tag with sensors and data processing capabilities, the tag memory may be used to store sensor data and also interface with the microcontroller. For applications involving data logging, parameters such as the logging interval may be stored in non-volatile words before a command starts the logging process. Large read/write data storage of the order of 128 kb, with sophisticated data search and access capabilities with active and semi-active RFID tags may be used. Embodiments of an RFID tag may include Impinj's Monza X-2K Dura RFID chip and Impinj's Monza X-8K Dura UHF RFID chip. Those skilled in the art should appreciate that there may be other embodiments of a receive and transmit subsystem.

Embodiments of receive and transmit subsystems may include an antenna. The antenna may be robust, inexpensive, lightweight, and small enough to be integrated on the probe. In addition, it may have omnidirectional or hemispherical coverage, provide maximum possible signal to the receiver, and have a polarization matched to the interrogator signal regardless of the physical orientation of the probe. Embodiments of omnidirectional antennas may include the dipole and the folded dipole, with bandwidths of 10-15% and 15-20%, respectively. Those skilled in the art should appreciate that there may be other embodiments of an antenna.

In one embodiment, the probe may include specifications in accordance with the following Table 1:

TABLE 1
Probe Example Specifications:

Size: (<10 cm); Mass: ≦1 gm; Terminal velocity: ≦0.5 meter per second (m/s) in calm wind
Measurement type: air temperature (T), pressure (P), relative humidity (RH), velocity (V),
position (x, y, z)
Measurement accuracy: T (0.25 C.); P (0.001 atm); RH (2%); V (1 m/s), position (25 m)
Measurement frequency: ≦5 minutes
Dynamic range: temperature (−70 to 40 C.); humidity (0 to 100%); pressure (0.1 to 1.0 atm);
velocity (<150 m/s)
Communication: transmit low power (order −20 dB) signals
Form factor: suitable for automatic deployment from aircraft or balloons
Deployment: No manual preparation for power on, calibration, etc.
Operation: all hours of day and night for up to 24 continuous hours

Under certain conditions, winds may accelerate probes to higher speeds (e.g. thunderstorm updrafts) or drifting probes may encounter aircraft traveling at higher speeds. In these instances, the collision hazard may be more significant. However, these probes may have substantially lower mass compared with birds (hundreds of grams to a kilogram or more) that typically pose a strike threat to airframes, windshields, and engines.

Table 2 lists suitable example components with various attributes including size and mass parameters. These components may be used to estimate the probe power budget. Microsensors may be used to measure ambient air temperature (T), relative humidity (RH), pressure (P), and velocity (V). Separate antennas may be needed for the RF transmitter and micro GPS because these components may operate at different frequencies (900 MHz versus 1.5 GHz, for example). The micro GPS module may require an external antenna and several additional components. Possible candidates for the antenna include dipoles, folded dipoles, spirals, and planar elliptical patch. The optimal antenna configuration may be a custom design based on the probe form factor and overall component geometry.

TABLE 2
Probe components with attributes listed or not applicable
(N/A). Estimated mass is denoted as “est”.

| | | Mass | | Dynamic |
|---|---|---|---|---|
| Component | Size (mm) | (mg) | Accuracy | Range |
| T/RH sensor | 3.0 × 3.0 × 1.1 | 25 | ±0.2° C.; | −40 to 125° C.; |
| | | | 1.8% | 0 to 100% |
| Pressure sensor | 3.6 × 3.8 × 0.93 | 26 | 0.001 atm | 0.3 to 1.0 atm |
| Micro GPS | 10.1 × 9.7 × 2.5 | 200 (est) | 0.1 m/s; | 500 m/s, |
| | | | 2.5 m | 50 km |
| GPS Antenna | 4.0 × 4.3 × 6.3 | 33 | N/A | N/A |
| Zinc Air Battery | 5.8 (dia) × 2.2 | 200 | N/A | N/A |
| Microprocessor/RF | 4.0 × 4.0 × 1.0 | 169 | N/A | N/A |
| RF Antenna | 20.0 × 1.0 × 0.8 | 20 (est) | N/A | N/A |
| Interface | 1.0 to 5.0 | 25 (est) | N/A | N/A |
| electronics | | | | |
| Packaging | 20.0 to 30.0 | 75 (est) | N/A | N/A |

Interface electronics such as resistors, switches, wire bonds, etc. and packaging may be required to connect the main components. The packaging may need to isolate certain components from the effects of turbulence, liquid and frozen water as well as direct solar radiation. The total mass of all components in Table 2 is 973 mg (0.973 gm), and includes two zinc air batteries (200 mg×2) connected in series to achieve the required voltage for most components. The packaging may include printed circuit boards that may increase probe mass beyond 1-gm using the current suite of components. The power source may be, for example, by far the largest percentage of total probe mass at 41% and may be reduced using ultra-low power custom components.

Alternative strategies for component integration may include modular die-stacked structures, flexible substrates and components, and monolithic “systems on a chip”. It may be possible to fabricate bio-inspired designs with mass less than 200 mg and terminal velocity on the order of 0.5 m/s. In other embodiments, the mass may be less than 1 gram. In other embodiments, the mass may be about 10 grams. The mass may also be between 1 gram and 10 grams in other embodiments.

The microprocessor unit (MPU) may store a set of instructions, make measurements, store/process sensor data as well as control the active versus sleep cycles for the micro GPS and communication functions. An ultra-low power device drawing 160 μA/MHz with clock speeds up to 20 MHz is contemplated for the microprocessor unit. The RF transmitter may require roughly 33 mA to generate a 10-dB (10-mW) signal at 900 MHz. The microprocessor may also have a number of low-power modes that can be controlled with a real-time internal clock to limit power consumption as part of an overall probe sleep cycle. The other microprocessor attributes include 32 kilobytes (kB) of programmable flash memory, 4 kB of random access memory (RAM), high performance 12-bit analog-to-digital converter, six external inputs, and internal temperature plus battery sensors.

The microprocessor may be adequate to control all probe functions. For example, sensor data comprised of eleven different parameters (T, RH, P, three components of V, altitude, latitude, longitude, time, and ID) may be logged in memory at some pre-determined frequency then combined in a packet for transmission. The raw packet length may be about 125 bits given the accuracy and resolution needed to meet measurement specifications. Additional layers and error control bits may be used as part of the communication paradigm. The overall packet length of about 64 kbits along with the MPU instruction set (i.e. control software) may be stored in flash memory.

A key challenge in miniaturization is energy density and power consumption. Energy density scales with volume and suitable power sources such as small batteries may not provide high enough peak power output or energy capacity. The key design tradeoff may be to minimize component power requirements and effectively manage available power using ultra low-power or sleep modes. In order to explore power source options, a power budget (Table 3) is shown using component specifications from Table 3.

The measurement frequency listed in Table 3 corresponds to acquiring T, RH, and P sensor data every 30 s (0.5 min) with velocity and position data every 120 s (2 min). The microprocessor may then transmit the ten-parameter packet every 120 s (2 min). The microprocessor may operate in an active mode 5% of the time and be in a much lower power state (i.e. sleep mode) for the remaining 95% of operational cycle. In other embodiments, the microprocessor may operate in an active mode at most 10% of the time and be in a much lower power state (i.e. sleep mode) for the remaining at least 90% of operational cycle. It should be understood that in other embodiments, the active mode may be active more or less than the sleep mode. For example, the active mode may be active 5% of the time and the sleep mode may be operating 95% of the time. The active mode may be active for 50% of the time or more if the power consumption of the device is extremely low. For a 6-h period, that time split may correspond to 1080 s (18 min) active versus 20,520 s (342 min) in a sleep mode. If the microprocessor is operated at 8 MHz drawing 160 μA/MHz at 3 V, the total power consumed over 6 h may be 8 MHz×160 μA/MHz×0.000001 A/μA×3 V×0.05×21600 s or 4.1 J. The same calculation may be performed for the low power or standby mode that uses 2 μA at 3 V.

The total energy required to operate a probe for 6 hours in this embodiment may be roughly 48.5 J. Two exemplary batteries connected in series, for example, may produce 35 mAh at 2.8 V or about 352.8 J (0.035 A×2.8 V*3600 s/h). This energy may be sufficient to operate the probe for more than 36 h with a significant margin of ˜60 J. Given this surplus energy, GPS measurement and transmission frequency may be increased to match the T, RH, and P sensors at 0.033 Hz (i.e. every 30 s). This mode of operation may require 139.7 J so the probe may still operate for 12 h with a margin of ˜70 J.

The last column in Table 3 shows that the micro GPS may, in the exemplary embodiment, use more than two thirds of the total energy (67.6%) and more than double the radio. The tradeoffs relative to the energy budget suggest that decreasing the GPS and radio energy requirements may extend the probe operating time given the same energy density or require a lower capacity and potentially less massive power source.

TABLE 3
Probe energy requirements computed from component data sheet specifications.

| | | | | (d)* | Total |
|---|---|---|---|---|---|
| | (a) | (b) | (c) | Total Energy | Energy |
| | Measurement | Standby | Energy Per | For 6-h | For 6-h |
| | Frequency | Energy | Measurement | Operation | Operation |
| Component | (Hz) | (J) | (J) | (J) | (%) |
| T/RH sensor | ( 1/30) | 3.3 × 10⁻⁵ | 2.7 × 10⁻⁵ | 4.3 × 10⁻² | 0.1 |
| Pressure sensor | ( 1/30) | 6.0 × 10⁻⁶ | 6.5 × 10⁻⁶ | 9.0 × 10⁻³ | <0.1 |
| Micro GPS | ( 1/120) | 2.5 × 10⁻³ | 1.1 × 10⁻¹ | 20.1 (+ 12.7)^{@} | 67.6 |
| Radio | ( 1/120) | 5.2 × 10⁻⁴ | 6.3 × 10⁻² | 11.4 | 23.5 |
| Microprocessor | — | 0.1^{#} | 4.1^{#} | 4.2 | 8.7 |
| Total | — | — | — | 48.5 | 100 |

*Except for the microprocessor, total energy computed as (column b + column c) × (21600 s) × (column a)
^{#}Energy for microprocessor estimated based on active (5%) versus sleep (95%) mode
^{@}may include a warm start every hour to update ephemeris data (0.047 A × 1.8 V × 30 s × 5 updates = 12.7 J)

In another embodiment, an alternate method for probe communication may address the shortfalls of RFID and provide a potentially more robust communication. The probe radio may, in this embodiment, transmit data packets at a constant power level of 10 mW (−20 dB) using an onboard radio in the MHz range at pre-determined intervals. In this embodiment, a step may be included which pads the data packets with extra bits before transmission using a signal processing technique called forward error correction (FEC). When combined with code division multiple access, hundreds of probes may be capable of transmitting on the same frequency without interference.

The FEC communication protocol may provide gain similar to antennas or amplifiers that increase signal strength, effectively lowering the noise floor so that weaker signals may be detected at greater ranges and decoded with fewer errors. However, the scheme may increases the packet size by adding a sequence of bits known as pseudo-random noise or chips so the effective transmission rate after accounting for the additional bits may be much lower. This increase in packet size may not be deemed significant for the current application because FEC could overcome range issues with the radar responsive RFID paradigm while simplifying the overall communication and interrogation requirements.

A sample link budget for probes using FEC is shown in Table 4. The transmission frequency may be, in this embodiment, 900 MHz with 512 bits per chip but no atmospheric attenuation or receiver antenna polarization loss. The free space loss over a path length of 250 km may be computed using the standard Friis transmission equation and system noise power as kTB where k is the Boltzmann constant, T is temperature, and B is receiver bandwidth. The metric to evaluate the link budget may be the energy per bit to noise ratio (E₀/N₀). This quantity may be effectively a normalized signal-to-noise ratio that accounts for the additional gain using FEC. The E₀/N₀ may be, in this embodiment, estimated to be 12 dB over a range of 250 km, leaving a 2 dB margin at the receiver if the minimum E₀/N₀ is 10 dB. The link budget may be computed at different ranges and include other losses or gains in the system or environment.

TABLE 4
Sample probe link budget using forward error correction.

| Parameter | Value | Units |
|---|---|---|
| Transmitter (Probe) | | |
| Power | −20 | dB |
| Antenna gain | 0 | dB |
| Frequency | 900 | MHz |
| Path length | 250 | km |
| Free-space loss | −146 | dB |
| Receiver (Fixed or Mobile) | | |
| Antenna gain | 5 | dB |
| Temperature | 300 | K |
| Noise factor | 5 | dB |
| Bandwidth | 50 | kHz |
| System Noise (N₀) | −139 | dB |
| Signal Encoding | | |
| Chip Rate | 64 | kbps |
| Chips/Bit | 512 | |
| Effective Data Rate | 125 | bps |
| Signal Processing Gain | 27 | dB |
| Link Quality | | |
| Received Power | −154 | dB |
| E_{b}/N₀ | 12 | dB |
| Minimum E_{b}/N₀ | 10 | dB |
| Margin | 2 | dB |

The communication protocol using FEC may thereby increase probe detection range by at least a factor of ten compared with the radar responsive RFID tags. The primary limitation may then become RF unobstructed line-of-sight which depends on altitude of the transmitter and receiver as well as obstructions such as trees, buildings, and hills. For an aircraft flying at 10 km over open water, the line-of-sight horizon is greater than 400 km. However, a fixed or mobile ground-based receiver would likely have more limited range as most locations do not have clear line-of-sight to the horizon at zero elevation angles. The extended range capability of the alternate communication strategy would be most advantageous for airborne receivers such as those carried onboard hurricane reconnaissance aircraft.

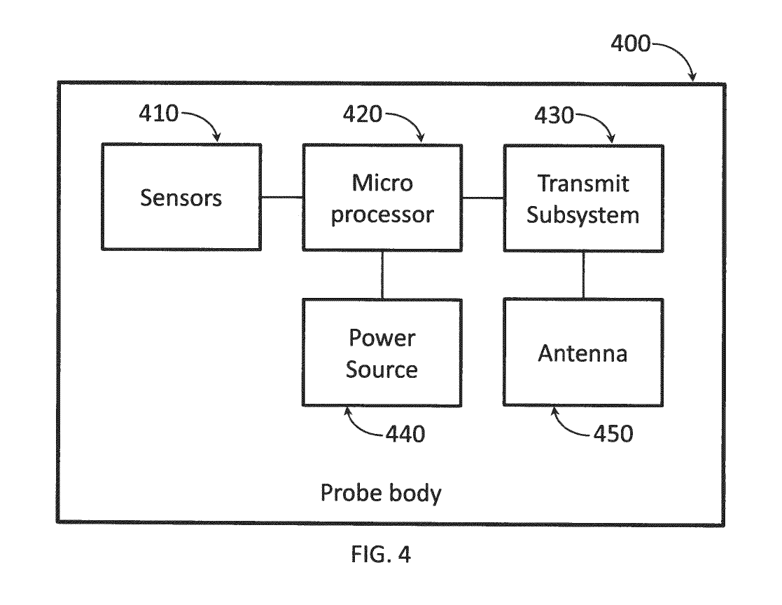

Referring now to FIG. 4, another embodiment of a passive, drifting airborne probe 400 includes sensors 410, a microprocessor 420, a transmit subsystem 430, an antenna 450, and a power source 440. The airborne probe 400 shown in FIG. 4 may be similar to the airborne probe 100 shown in FIG. 1. However, unlike the probe 100 shown in FIG. 1, the probe 400 may not include a receiver subsystem but instead may simply include the transmit subsystem 430 and the antenna 450. Using FEC technology, the probes 400 may only be configured to transmit information via the antenna 450. There may not be a need for receiving any information in this embodiment. However, it should be understood that other probes using FEC technology may include a receive subsystem.

Referring to the drawings, FIG. 1A depicts an embodiment of a passive, drifting airborne probe 160. Embodiments of apparatus 160 may include those disclosed above for passive, drifting airborne probes. In one embodiment of a passive, drifting airborne probe 160, the shape is based on an aerodynamic, bio-inspired design such as a dandelion seed. Furthermore, one embodiment of apparatus 160 may include a mass of approximately 1 gram. Those skilled in the art should appreciate that there may be other embodiments of a passive, drifting airborne probe.

Referring to the drawings, FIG. 2 depicts a flow diagram of a method for collecting and transmitting data about an environment 200. Embodiments of method 200 may include the steps of providing a passive, drifting airborne probe body 210, releasing the passive, drifting airborne probe body via a deployment mechanism 220, collecting data about an environment via the probe body 230, transmitting the data about the environment from the probe body 240, and collecting the data about the environment at an interrogation platform 250.

Embodiments of method 200 may include providing a passive, drifting airborne probe body 210. Embodiments of a passive, drifting airborne probe body may be the same or similar to those disclosed previously. Embodiments of providing a passive, drifting airborne probe body may include providing one or more probe bodies. Embodiments of providing a passive, drifting airborne probe body may include manufacturing, delivering, producing, constructing, assembling, fabricating, or supplying. Additionally, embodiments of providing a passive, drifting airborne probe body may include loading the passive, drifting airborne probe body onto the deployment mechanism. Embodiments of loading the probe body onto the deployment mechanism may include attaching, inserting, introducing, fastening, connecting, or packing the probe body onto the deployment mechanism. Those skilled in the art should appreciate that there may be other embodiments of providing a passive, drifting airborne probe body.

Embodiments of a deployment mechanism may include an aircraft such as an airplane or a helicopter, a weather balloon, a hot air balloon, or a rocket. Embodiments of aircraft may include manned as well as unmanned aircraft. The aircraft may be equipped with hardware to release small, cylindrical instrument packages known as dropsondes. The dropsonde deployment tubes may be large enough to accommodate tens to hundreds of probe bodies that may be encapsulated in a dropsonde cylinder or other rigid packaging to withstand ejection from the aircraft. In one embodiment of deploying the probes from an aircraft, an aerodynamic pod may be built on the aircraft exterior to facilitate deployment. Those skilled in the art should appreciate that there may be other embodiments of a deployment mechanism.

Furthermore, embodiments of method 200 may include releasing the passive, drifting airborne probe body via a deployment mechanism 220. Embodiments of a deployment mechanism may include those disclosed above. Embodiments of releasing a probe body may include releasing one or more probe bodies from the deployment mechanism. Releasing a cluster of probes may provide redundancy in the event of a single probe component malfunction or failure.

The probes may be deployed in several ways including from aircraft or as payloads on weather balloons. The deployment strategy may depend on a number of factors such as the phenomena of interest, areas to be covered, and probe terminal velocity. Standard weather balloons may be released twice daily by the National Oceanic and Atmospheric Administration (NOAA) National Weather Service (NWS) around the U.S. at stations separated by hundreds of kilometers. A more targeted observing capability using manual or automated balloon launchers as well as manned or unmanned aircraft may be used. Given the proposed probe mass and size, even small aircraft may be used to carry a substantial number of probes for research and operational missions.

Embodiments of releasing the passive, drifting airborne probe body via a deployment mechanism may also include using numerical weather prediction (NWP) modeling to estimate probe deployment and dispersion. Specialized versions of NWP models may be used to estimate times, locations, and altitudes where having additional measurements are most likely to improve short-range forecasts of specified parameters. This strategy is known as targeted or adaptive observing. Targeted observing may make it practical and cost-effective to operate the system because forecast sensitivities change depending on season, weather feature, and geographical location. With this approach, it may not be necessary to make measurements everywhere or realize only marginal benefits from instrumentation deployed at fixed locations that may not always be in sensitive regions.

Still further, embodiments of method 200 may include collecting data about an environment via the probe body 230. Data about the environment may be the same as that disclosed above. Embodiments of collecting the data may include collecting the data via the sensors attached to the probe body. Embodiments of sensors may be the same as those disclosed above. Embodiments of collecting the data may include detecting, sensing, reading, calculating, computing, measuring, determining, evaluating, or quantifying the data. Those skilled in the art should appreciate that there may be other methods of collecting data about an environment via the probe body.

Embodiments of method 200 may also include transmitting the data about the environment from the probe body 240. Embodiments of transmitting the data about the environment from the probe body may include the use of a radio frequency identification (RFID) tag. RFID tags may be radar-responsive, active, or semi-active. Embodiments of transmitting the data about the environment from the probe body may also include the use of FEC. Embodiments of transmitting the data about the environment from the probe body may also include the use of a transmit subsystem on the probe body. Embodiments of a transmit subsystem may be the same as those disclosed above. Embodiments of transmitting the data about the environment from the probe body may also include transmitting the data wirelessly through electromagnetic fields or radio waves. Further, embodiments of transmitting the data about the environment from the probe body may also include the use of an interrogator to send a signal to the tag and read its response. Embodiments of RFID tags may use frequencies in the 1 GHZ to 10 GHZ range. Embodiments of FEC may use frequencies in the MHz to GHz range. In other words, the FEC has a much larger freedom to operate at a wider range of frequencies, and more particularly, at much lower frequencies (MHz instead of GHz) when compared to RFID. In one embodiment, the FEC may use frequencies between 500-1000 MHz. Those skilled in the art should appreciate that there may be other embodiments of transmitting the data about the environment from the probe body.

Additionally, embodiments of method 200 may include receiving and processing the data about the environment at an interrogation platform 250. An interrogation platform may include airborne or ground based Doppler radars. Embodiments of receiving and processing the data about the environment at an interrogation platform may include receiving data from a probe within an intercepted volume for a given range gate and processing the data during the interpulse time interval before data from the next range gate are collected.

The interrogator operating frequency may include 1 GHZ to 10 GHZ. The operation of a radar interrogator may include the monostatic mode, wherein the transmitter and the receiver are collocated and usually share the same antenna. A mobile system may be used where the radar can move around and perform interrogation at any selected location close to where the atmospheric parameters need to be measured. This arrangement may allow the user to optimize the operating frequency.

An alternate mode of operation may include a bistatic configuration where the transmitter and receiver are separated usually by distances of a few kilometers. In this case, the interrogation may be provided by a high power transmitter and fixed or mobile units operate in the receive-only mode to process data from the probes. An embodiment of the interrogator may include the NWS Weather Surveillance Radar-1988 Doppler (WSR-88D) deployed throughout the U.S. which operates at a frequency of 2.8 GHz (S-Band) with 750 kW of transmitted power.

Several modulation schemes may be used to convert the physical quantity being measured by sensors onboard the probe into an electrical signal that can be conveyed back to the radar for processing. Each sensor may provide a voltage output that needs to modulate the incoming interrogation signal in a way that encodes the physical quantity being measured. One approach may include the use of delay modulation.

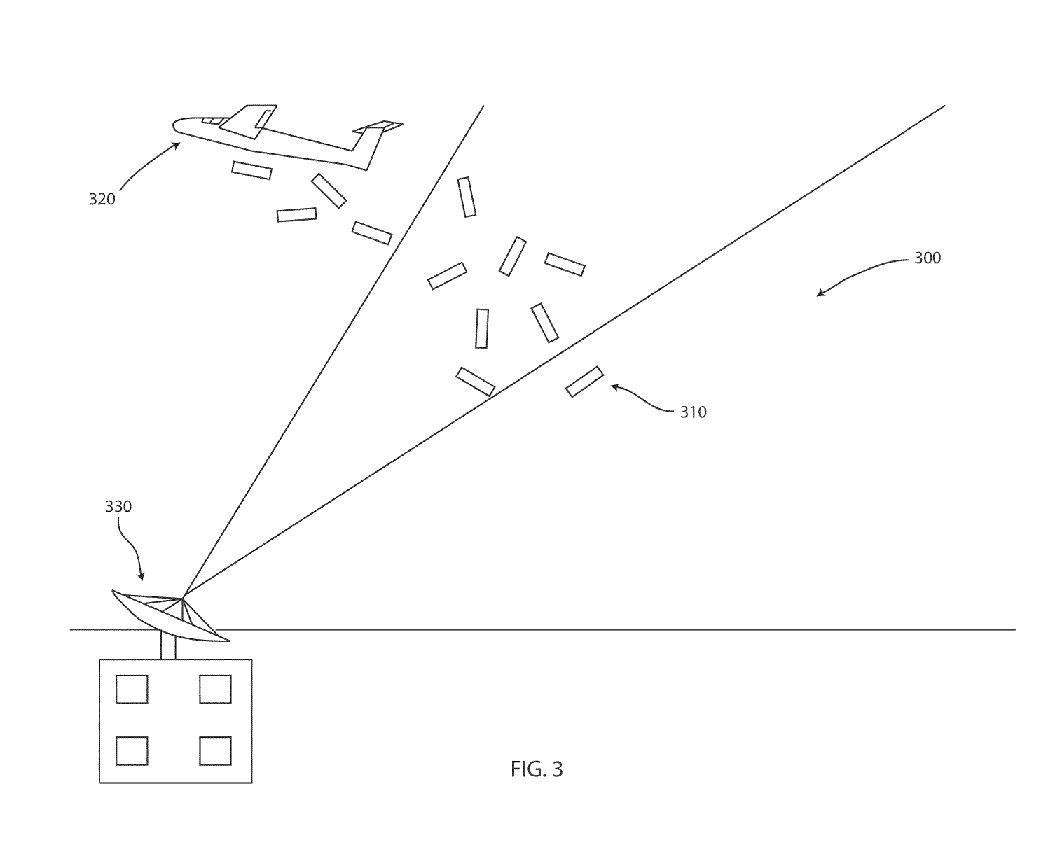

Referring to the drawings, FIG. 3 depicts a system 300 for collecting and transmitting data about an environment 300. Embodiments of system 300 may include a passive, drifting airborne probe body 310, a deployment mechanism 320, and an interrogation platform 330. The interrogation platform 330 may be, for example, a satellite dish that includes both a transmitter and receiver and may be configured to transmit signals to the airborne probe bodies 310 to wake up the probes 310 and modulate the probes 310 with embedded sensor data. In this embodiment, because the satellite dish clearly shows communication technology for transmitting information to the airborne probe bodies 310, the airborne probe bodies 310 may include an RFID communication structure to utilize this communication. However, other forms of communication are contemplated.

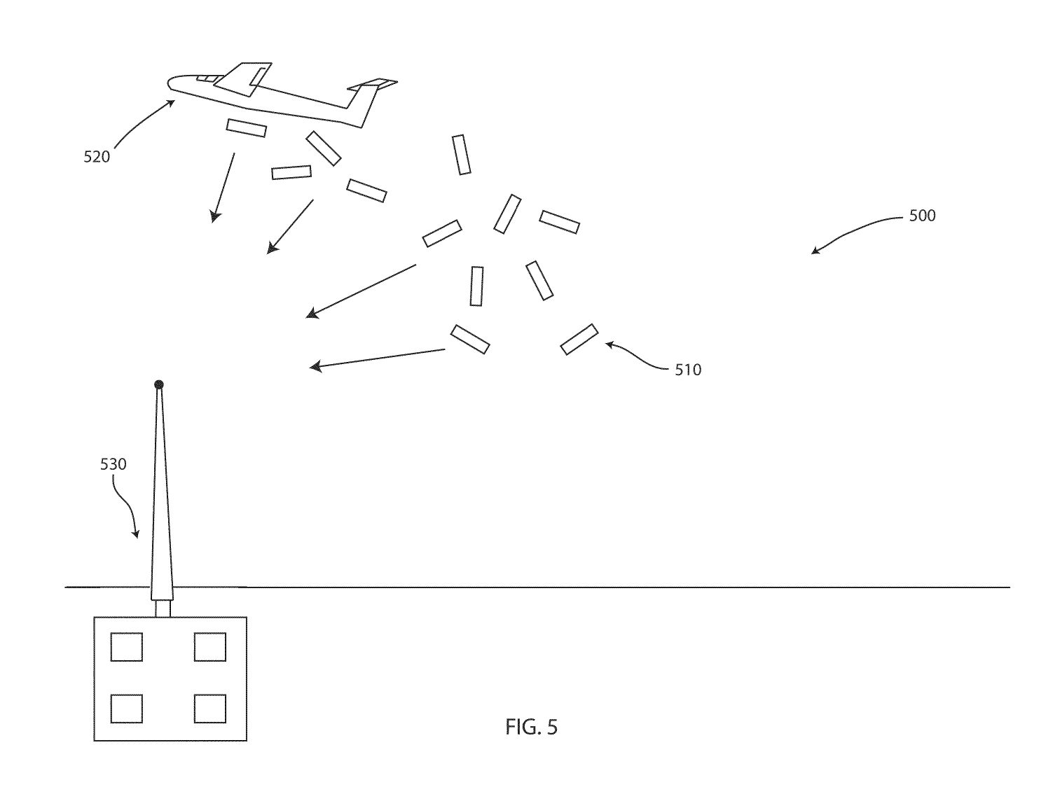

Referring still to the drawings, FIG. 5 depicts a system 500 for collecting and transmitting data about an environment 500. Embodiments of system 500 may include a passive, drifting airborne probe body 510, a deployment mechanism 520, and a receiving platform 530. The receiving platform 530 may be, in this embodiment, an antenna that includes only receiving technology as a communication mechanism with the passive, drifting airborne probe bodies 510. The antenna or receiving platform 530 may still be configured to transmit data to other locations. However, in this embodiment, the passive, drifting, airborne probe bodies 510 may use FEC and therefore may not require receive signals from a mobile or fixed interrogator. Rather, the airborne probe bodies 510 are shown transmitting information, via FEC, to the antenna.

Embodiments of systems 300, 500 may include a passive, drifting airborne probe body 310, 510. Embodiments of a passive, drifting airborne probe body may include those disclosed above. Embodiments of systems 300, 500 may also include a deployment mechanism. Embodiments of a deployment mechanism may include those disclosed above. Furthermore, embodiments of system 300 may include an interrogation platform 330, 530. Embodiments of an interrogation platform may include those disclosed above. Those skilled in the art should appreciate that there may be other embodiments of a system for collecting and transmitting data about an environment.

Referring to the drawings, FIG. 5 depicts a system for collecting and transmitting data about an environment 500. Embodiments of system 500 may include a passive, drifting airborne probe body 510. The probe body 510 may be similar to the probe 400 shown in FIG. 4. In other words, the probe body 510 may be configured to utilize a deployment mechanism 520, and a receiver platform 530.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the invention, as required by the following claims. The claims provide the scope of the coverage of the invention and should not be limited to the specific examples provided herein.

What is claimed is:

1. A drifting airborne probe comprising:
a body having an aerodynamic shape that is biologically inspired by a wind dispersible natural seed;
a total mass of less than 10 grams;
a power source operably connected to the body;
at least one sensor operably connected to the body for collecting data from the environment and about the environment;
a transmitter for transmitting the data operably connected to the body; and
no active propulsion system.

2. The drifting airborne probe of claim 1, wherein the wind dispersible natural seed is a seed selected from the group consisting of a dandelion seed, a maple seed, a whirlybird, a samaras, an Asian climbing gourd winged seed, a western salsify seed, a whirling nut of the Gyrocarpacea family of trees, and a hopseed bush spinner.

3. The drifting airborne probe of claim 1, wherein the total mass is less than 2 grams.

4. The drifting airborne probe of claim 1, wherein the total mass is between 1 and 0.01 grams.

5. The drifting airborne probe of claim 1, wherein the aerodynamic shape and the mass allow the probe to remain airborne for at least 50 minutes in a calm environment when released at an altitude of 3 km above ground.

6. The drifting airborne probe of claim 1, further comprising a microprocessor, wherein the microprocessor is configured to operate in an active mode for at most 10% of the time and configured to enter a sleep mode for at least 90% of the time.

7. The drifting airborne probe of claim 1, wherein the transmitter generates data using a forward error correction communication protocol.

8. The drifting airborne probe of claim 7, further comprising a receiver, wherein the receiver is configured to receive signals generated by the forward error correction communication protocol.

9. The drifting airborne probe of claim 1, further comprising a GPS tracking device.

10. The drifting airborne probe of claim 1, wherein the transmitter is configured to transmit signals generated by a forward error correction communication protocol.

11. A method for collecting and transmitting data about an environment comprising:
providing a plurality of drifting airborne probes each including:
a body having an aerodynamic shape that is biologically inspired by a wind dispersible natural seed;
a total mass of less than 10 grams;
a power source operably connected to the body;
at least one sensor operably connected to the body for collecting data from the environment and about the environment;
a transmitter for transmitting the data operably connected to the body; and
no active propulsion system;
releasing the drifting airborne probe with a deployment mechanism;
collecting the data about the environment via the sensor; and
transmitting the data to a receiver platform via the transmitter.

12. The method of claim 9, wherein the wind dispersible natural seed is a seed selected from the group consisting of a dandelion seed, a maple seed, a whirlybird, a samaras, an Asian climbing gourd winged seed, a western salsify seed, a whirling nut of the Gyrocarpacea family of trees, and a hopseed bush spinner.

13. The method of claim 9, wherein the total mass is less than 2 grams.

14. The method of claim 9, wherein the total mass is between 1 and 0.01 grams.

15. The method of claim 9, further comprising remaining airborne, with each of the plurality of drifting airborne probes for at least 50 minutes in a calm environment when released at an altitude of 3 km above ground.

16. The method of claim 9, wherein each of the plurality of drifting airborne probes further include a microprocessor, and wherein the method further comprises operating the microprocessor of each of the plurality of drifting airborne probes in an active mode for at most 10% of the time and entering a sleep mode by the microprocessor for at least 90% of the time.

17. The method of claim 9, further including generating data, by the transmitter, using a forward error correction communication protocol.

18. The method of claim 15, wherein each of the drifting airborne probes further include a transmitter, wherein the method further comprises transmitting signals, by the transmitter of each of the drifting airborne probes, generated by the forward error correction communication protocol.

19. The method of claim 1, wherein each of the plurality of drifting airborne probes further includes a GPS tracking device.

20. A system for collecting and transmitting data about an environment comprising:
a plurality of drifting airborne probes each including:
a body having an aerodynamic shape that is biologically inspired;
a total mass of less than 10 grams;
a power source operably connected to the body;
at least one sensor operably connected to the body for collecting data from the environment and about the environment;
a transmitter for transmitting the data operably connected to the body, wherein the transmitter generates data using a forward error correction communication protocol; and
no active propulsion system;
a mechanism to deploy the plurality of drifting airborne probe bodies; and
at least one receiver platform, the receiver platform generating signals that are receivable by the plurality of drifting airborne probes using the forward error correction communication protocol.

21. The system for collecting and transmitting data about the environment of claim 20, wherein each of the plurality of drifting airborne probes further include a microprocessor, and wherein the method further comprises operating the microprocessor of each of the plurality of drifting airborne probes in an active mode for at most 10% of the time and entering a sleep mode by the microprocessor for at least 90% of the time.

22. The system for collecting and transmitting data about the environment of claim 20, wherein the aerodynamic shape is biologically inspired by a biological entity selected from the group consisting of a dandelion seed, a maple seed, a whirlybird, a samaras, an Asian climbing gourd winged seed, a western salsify seed, a whirling nut of the Gyrocarpacea family of trees, and a hopseed bush spinner.

23. The method of claim 20, wherein each of the plurality of drifting airborne probes further includes a GPS tracking device.
